(19) United States
(12) Patent Application Publication
(10) Pub. No.: US 2020/0393660 A1
(43) Pub. Date: Dec. 17, 2020

(54) METHOD AND OPTICAL ARRANGEMENT FOR ASCERTAINING A RESULTANT POWER OF RADIATION IN A SAMPLE PLANE

(71) Applicant: Carl Zeiss Microscopy GmbH, Jena (DE)

(72) Inventor: Wolfgang BATHE, Jena (DE)

(73) Assignee: Carl Zeiss Microscopy GmbH, Jean (DE)

(21) Appl. No.: 16/902,466

(22) Filed: Jun. 16, 2020

(30) Foreign Application Priority Data
Jun. 17, 2019 (DE) 102019208760.4

(51) Int. Cl. G02B 21/00; G02B 21/36

(52) U.S. Cl. CPC G02B 21/0032; G02B 21/0052; G02B 21/36

(57) ABSTRACT

A method and an optical arrangement for ascertaining a resultant power of radiation in a sample plane (8) of an optical arrangement. In a step A, a current configuration of optical elements in a beam path of the optical arrangement is captured. In a step B, radiation is provided and directed into the sample plane (8) along the beam path. At least one measured value of the power of the radiation in the sample plane (8) is captured as resultant power in step C and the measured values in respect of the respectively current configuration are stored in a step D. Steps A to D are repeated for at least one further current configuration.

### RELATED APPLICATIONS

The present application claims priority benefit of German Application No. DE 10 2019 208 760.4 filed on Jun. 17, 2019, the contents of which is incorporated by reference in its entirety.

### FIELD OF THE INVENTION

The invention relates to a method and an optical arrangement for ascertaining a resultant power of radiation in a sample plane of the optical arrangement.

In particular, the invention relates to microscopes in which parts of a sample to be imaged or to be observed are excited by means of electromagnetic radiation for imaging purposes. In order to be able to obtain high quality image data, the power of the radiation (radiant flux) emitted into the sample must be sufficiently high to trigger the desired effects. At the same time, the power must not be too high to prevent the sample from being damaged or even destroyed.

### BACKGROUND OF THE INVENTION

To achieve such monitoring of the power in the sample plane, the prior art has disclosed light sensors which are installed in optical arrangements such as a microscope, for example, in order to monitor the excitation power and, where necessary, also control this by means of appropriate closed-loop control devices. By way of example, such sensors can be installed directly in the used light sources such that the output power of the light sources can then be kept constant.

However, there still is the problem of the transmissions of the subsequent elements being unknown. It is consequently not possible to set the remaining excitation power, also referred to as resultant power below, in a targeted fashion in the sample or in the sample plane.

### SUMMARY OF THE INVENTION

An overview-type illustration of a microscope 10, in particular a laser scanning microscope, is provided in FIG. 1. When required, a plurality of light sources 1a to 1d (laser A to laser D) each make available radiation in the form of a laser light. Here, the respective instances of radiation can be guided separately (see light source 1a) or together in one beam path (light sources 1b to 1d).

The excitation light (radiation) generated in the light sources 1a, 1b, 1c, 1d reaches a main color splitter 4 via an attenuator 2a or 2b and collimators 3a, 3b and, from said main color splitter, it reaches a reflector turret 5, an output coupling means or secondary color splitter 6, and an objective 7 to the sample or to the sample plane 8. The terms sample 8 and sample plane 8 are used synonymously below. Light emitted by the sample is captured by way of the objective 7 and guided back. The captured detection radiation is split by means of various beam splitters DBS1 to DBS3, 6 and in each case guided to detectors via pinholes PH1 to PH4 and/or emission filters EF1 to EF5, said detectors being embodied as secondary electron multipliers (photomultiplier tubes) PMT1 to PMT5. In transmitted light, detection can be carried out using a transmission PMT T-PMT.

The power of the excitation light in the sample 8 can be set by virtue of the attenuators 2a, 2b being set to a certain transmission. By way of example, the setting can be implemented by way of the operator control elements of a control unit not plotted in FIG. 1 (see FIGS. 2 and 3).

Should the user wish to set a very specific power, e.g., 1 mW, the output powers of the light sources 1a-d and the transmissions of all subsequent optical elements in the beam path from the light sources to the sample 8 must be known. However, this is often not the case. Likewise, the output powers of the light sources or transmissions of elements in the beam path could be subject to long-term change, for example, and so a regular redetermination of the transmissions is necessary.

The problem of the elements with unknown transmission is only partly solved if light sensors are installed in the beam path closer to the sample plane, e.g., upstream of a main color splitter. Thus, optical elements downstream of the main color splitter, such as, e.g., reflector turret, secondary color splitter and objective may ultimately lead to an unknown excitation power in the sample.

Even if all transmissions of the elements downstream of a light sensor in the system are known, there is the problem of the light sensor itself needing to be subject to regular calibration in order to reliably capture the measured values. Such re-calibrations may be connected with great outlay. Thus, it may be necessary to remove the light sensor from the microscope in order to supply it to a calibration.

In any case, the described situation leads to microscopes regularly having no adjustment options which allow a certain excitation power in the sample to be set. Rather, only a relative adjustment of the excitation power is possible, for example by virtue of selecting and setting a percentage value of the maximum available excitation power.

However, since there nevertheless is a need for monitoring the excitation power in the sample, users use commercially available measuring devices for determining the excitation power in the sample plane. Typically, these are laser power measuring devices (laser power meters or laser power detectors). Below, these are also referred to simply as power meters. In the meantime, the manufacturers of such power meters have even reacted to the need for determining the excitation power in the sample plane of a microscope and now offer power meters with sensors, which are embodied like an object carrier and which can be installed in the sample plane particularly easily. Likewise, they permit immersion with an immersion medium (e.g., water, oil), and so the correct determination of excitation power is possible even if an immersion objective is located in the beam path.

A power meter 15 is illustrated schematically in FIG. 2. It has a measuring head 20 with a light-sensitive area, on which radiation to be measured must be applied. The measuring head 20 is connected to a display and operating unit 22 by way of a line 21. The display and operating unit 22 can have a display 23 and operator control elements 24. The measured luminous power can be indicated on the display 23. The operator control elements 24 can be provided for selecting an employed wavelength of the radiation or for switching the power meter 15 on and off. Furthermore, there often still is a connector 25 for connecting the power meter 15 to a computer, for example a PC, as a control unit 30 for control and read-out purposes. By way of example, the connector 25 can be embodied as a USB connector such that a connection to a commercially available PC is possible.

Some power meters 15 do not have a dedicated display and operating unit 22. Instead, the measuring head 20 is directly connected to a computer as a control unit 30. The full control and the readout of the measured values are implemented via the control unit 30.

As a rule, commercially available power meters 15 are supplied calibrated. The calibration has a validity duration, a re-calibration being necessary after the expiry thereof.

If a user of the microscope now decides to use a power meter 15 to determine, and subsequently set, the excitation power in the sample plane 8, said user has to use the power meter 15 again for each adjustment of the excitation power. If the intention is to modify the configuration of the microscope 10, for example to use a different objective 7, another measurement with the power meter 15 has to be carried out. Although the user can note down as respective configurations of the microscope 10 the values set in the microscope 10 for all excitation powers that have been realized once, and also restore these when necessary, this process is very cumbersome and susceptible to errors.

An object of the invention consists in proposing an option, improved over the prior art, of allowing the user of the microscope to set an excitation power to be realized.

This object is achieved by a method according to claim 1 and an optical arrangement according to claim 5. Advantageous developments are the subject matter of the dependent claims.

The method according to the invention for ascertaining a resultant power of radiation in a sample plane of an optical arrangement comprises steps A to D. Here, the current configuration of optical elements in a beam path of the optical arrangement is captured in step A. Thus, the optical elements currently situated in the beam path and/or the optical effects thereof in relation to employed radiation are/is captured and stored. Here, in addition to the physical presence of the relevant optical elements, a configuration is also understood to mean the implemented settings thereof, for example the current angle of incidence, output powers and/or transmission values. The term (current) configuration also includes temporarily caused optical effects set in a targeted fashion, as is the case for example, for a generated pattern of an appropriately driven AOTF (acousto-optic tunable filter) or adjustable grating.

In step B, radiation is provided, for example by means of a suitable light source of the optical arrangement or by coupling in radiation from an external light source. This radiation is directed along the beam path into the sample plane. Subsequently, at least one measured value of the power of the radiation in the sample plane is captured in a step C as a resultant power. The measured value, i.e., the resultant power, is stored in repeatedly retrievable fashion in relation to the current configuration in a step D. Steps A to D are repeated for at least one further current configuration.

The crux of the invention is to make available information about a resultant power of radiation in the sample plane in a manner assigned to a specific configuration of the optical arrangement. Advantageously, this can be used to set desired resultant powers in the sample plane, even if the current configuration of the optical arrangement is changed, without having to carry out new measurements.

### EMBODIMENTS OF THE INVENTION

In an advantageous embodiment of the method, a relationship between the resultant power and an output power of the radiation is ascertained on the basis of the stored measured values. By way of example, such a relationship can be expressed as a mathematical function. The relationship can also be stored in the form of an assignment of the respective parameter values, for example as a lookup table (LUT), and assigned to the at least one configuration.

By way of example, the relationship can be ascertained by means of known methods of regression and/or extrapolation, for example on the basis of a number of measured values for respective configurations. Advantageously, the value range of the mathematical relationship can be limited on the basis of the technical specifications of the light source, for example, in order to avoid unnecessary computing power and to indicate only physically implementable options to the user.

It is also possible for a further configuration to be established by virtue of, for example, an output power of the radiation and/or an attenuation effect of at least one of the optical elements being altered, for example incrementally increased or reduced. Otherwise, the optical elements in the beam path remain unchanged. In this way, it is possible to examine whether, or for what value ranges, there is, e.g., a linear relationship between the resultant power and the output power of the radiation. Unmeasured values (intermediate values) of the relationship can be efficiently extrapolated within linear ranges. In regions where there is a nonlinear relationship, intermediate values can be ascertained by means of simulation or corresponding nonlinear regressions and suitably chosen confidence intervals.

In one possible embodiment, the method according to the invention allows a desired resultant power in the sample plane of a configuration to be used to be selected and an output power of the radiation to be set on the basis of the stored measured values or on the basis of the relationship by means of appropriately generated control commands. By way of example, this can be implemented by a radiation source of the radiation and/or an attenuator disposed in the beam path being driven in such a way that the selected desired resultant power is brought about in the sample plane.

An attenuator is a component, the effect of which allows an intensity and/or a spectral composition of the radiation to be influenced in controlled fashion, at least over certain value ranges. By way of example, adjustable stops, AOTFs, AOMs (acousto-optic modulators), filters and gratings may serve as attenuators.

By way of example, the user can use the ascertained relationship in order to obtain a desired resultant power in the sample plane. To this end, the output power of the current configuration at which the desired resultant power is present is selected and set.

In order to obtain the measured values and optionally in order to ascertain the relationships between resultant power and output power in each case, it is possible to set and measure all conceivable or all probably practically relevant configurations. By way of example, all combinations of optical elements such as main color splitters, objectives, etc., could be measured. Although this procedure provides a comprehensive data basis, it may lead to a very large number of combinations and hence to a very long duration of the measurement processes.

In order to design the creation of the data basis more effectively, a selection of optical elements of a current configuration can be made in a further embodiment of the method. Steps A to D are only carried out for the selected optical elements. Resultant powers and/or output powers are ascertained by calculation or estimated for further possible configurations.

This shall be explained using an example. Suppose four different objectives and four main color splitters are available for an optical arrangement. In order to ascertain all combinations of these optical elements, sixteen measuring processes (four objectives×four main color splitters) would have to be carried out.

Alternatively, it is conceivable to initially measure, e.g., all four objectives using one of the main color splitters. Subsequently, all four main color splitters can be measured with one of the objectives. Overall, that is eight measurements. From the captured measured values, it is possible to deduce by calculation the corresponding resultant powers for all combinations of main color splitters and objectives. The advantage of this method embodiment lies in the smaller number of measurements. A disadvantage arising is that the measurement errors of the individual measurements of main color splitters and objectives add up. Thus, the calibration process is performable comparatively quickly but is not as precise as a measurement or calibration of all configurations.

The above-described procedure can be extended to all further optical elements to be taken into account in the beam path. Thus, a decision can be made for each individual optical element as to whether it is calibrated separately or in combination with the other elements. Then, this allows a method embodiment which both is as quick and efficient as possible and also achieves sufficient calibration accuracy to be selected and carried out. In further embodiments of the method, it is also possible for only some of the possible configurations to be measured, and for only the corresponding measured values and mathematical relationships for these to be respectively stored and ascertained.

The method can be carried out in automated fashion. At the start, the user must bring the measuring head of the power meter into the sample plane. If objectives should also be calibrated with various immersions, the user must apply the corresponding immersion under certain circumstances. To this end, a prompt for the user can be provided, which is transmitted to the latter visually and/or acoustically, for example.

If the microscope requires further manual interventions, the user may also have to carry these out under certain circumstances. Otherwise, the calibration can be performed fully automatically and hence as easily as possible for the user.

The method can be carried out using optical arrangements designed for excitation and imaging in the wide field, or as point or line scanners. Advantageously, the method is usable if the employed radiation only covers a narrow wavelength range or is monochromatic. A narrow spectral width of the radiation leads to more accurate measured values and, as a consequence, also allows more precise ascertainment of the relationships between resultant power and output power. Thus, the use of a laser or monochromatic light source for generating the radiation is advantageous.

The user can intermittently repeat the method in order to compensate aging-related drift of the light sources, for example. The method could also be repeated automatically after a certain amount of time, after a certain number of measurement processes, after a certain number of operating hours of individual components of the microscope or after a qualitative evaluation of the features of captured images.

Since the automated method implementation requires few user interactions it is easily performable. By way of example, the user need not note down any values in order to be able to set a subsequent excitation power. On account of the automation, the user can carry out other activities during the running calibration.

In turn, the power meter can be calibrated independently of servicing intervals of the microscope. By way of example, the microscope can be used with a power meter still in the calibration interval. Subsequently, the power meter itself can be supplied to the calibration so that it can be subsequently used again for a calibration of the microscope. During the period of time in which the power meter is calibrated, the microscope is available without restrictions and the user does not have to deal with downtime.

Likewise, the user may decide to calibrate the power meter less frequently than envisaged or not at all. Although they will also receive a less reliable calibration of the excitation power of the microscope in that case, this may be entirely sufficient for their application. The user obtains flexibility and can thus, e.g., reduce calibration costs for the power meter if they have reduced demands in respect of the accuracy of the calibration.

The object of the invention is achieved by an optical arrangement which, in particular, is a constituent part of a microscope. The optical arrangement has a beam path, along which radiation can be directed onto a sample plane. The optical arrangement comprises a light source for providing the radiation; optical elements for guiding and influencing radiation in the beam path; a measuring apparatus for capturing a resultant power of the radiation in a sample plane, and a control unit embodied to drive the light source and/or at least one of the optical elements.

The optical arrangement is characterized in that the measuring apparatus is connected to the control unit in a form suitable for the transmission of data. Moreover, the control unit is configured to capture a current configuration of optical elements in the beam path of the optical arrangement and to store the measured value in relation to the current configuration. Furthermore, the control unit is embodied to ascertain a relationship between the resultant power and an output power of the radiation on the basis of the stored measured values; and it serves to generate control commands for setting an output power of the radiation on the basis of the stored measured values or on the basis of the relationship.

The control unit can be subdivided into sections, either physically or functionally, in which the aforementioned processes of capturing, ascertaining, generating and driving are each carried out or can each be carried out. A control unit can be a computing device (computer), for example a PC.

A power meter can be introduced into the sample plane. Said power meter is advantageously calibratable. The optical arrangement, in particular the control unit, and the power meter are interconnectable in terms of data transfer. To this end, both may have, e.g., plugs and/or data lines, for example according to a USB standard. A connection suitable for the transmission of data can also be established contactlessly by radio and/or by optical transmission.

The microscope can be a wide-field microscope or a scanning microscope, for example a laser scanning microscope. The microscope can be confocal.

Advantageously, laser light sources and/or monochromatic light sources can be present as at least one light source. The narrow spectral range thereof is advantageous for the embodiment of the method according to the invention (see above).

The microscope can have a main color splitter, a reflector turret and/or a plurality of objective receptacles.

The power meter or the measuring head thereof can be embodied in the form of an object carrier, for example. Moreover, it may be suitable for immersion and/or have a connector such as, e.g., a USB connector (plug or socket).

The power meter could consist of purely the measuring head with a connector. By way of example, a light-sensitive sensor of the measuring head can be a photodiode or a thermal power sensor.

### BRIEF DESCRIPTION OF THE DRAWINGS

The invention will be explained in more detail below on the basis of figures and exemplary embodiments. In detail:

FIG. 1 is a schematic illustration of a microscope according to the prior art;

FIG. 2 is a schematic illustration of a power meter according to the prior art;

FIG. 3 is a schematic illustration of an exemplary embodiment of an optical arrangement according to the invention; and

FIG. 4 is a flowchart of an embodiment of the method according to the invention.

### DETAILED DESCRIPTION OF THE INVENTION

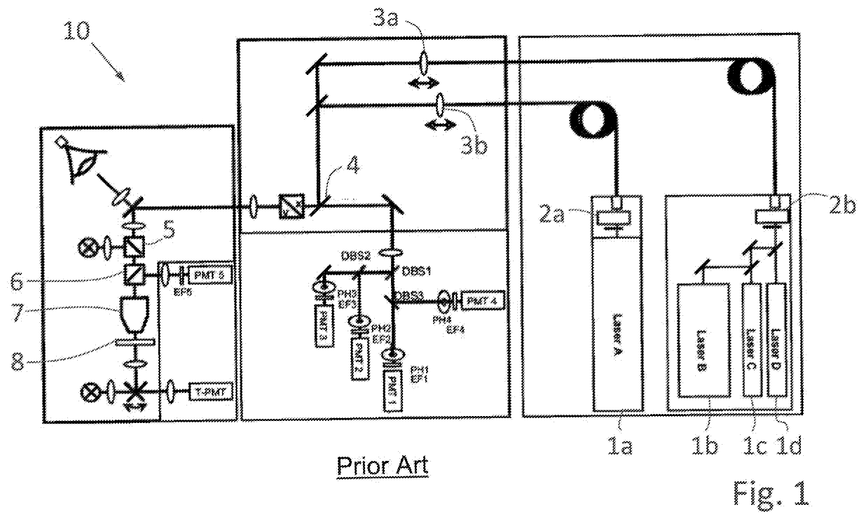

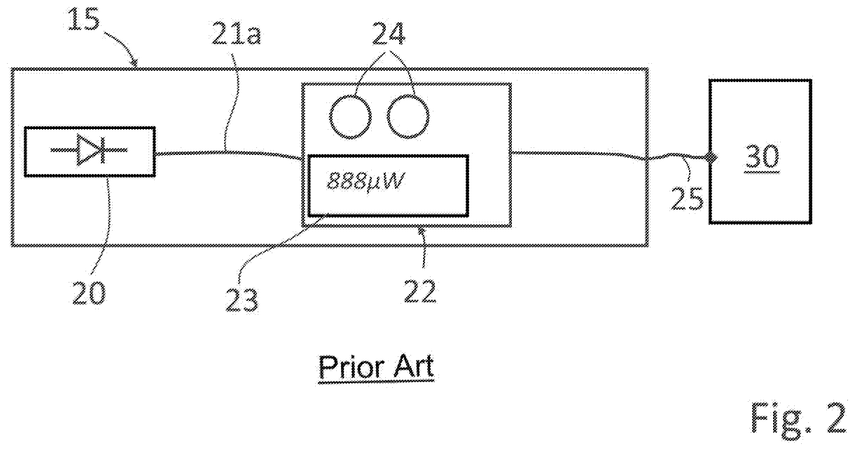

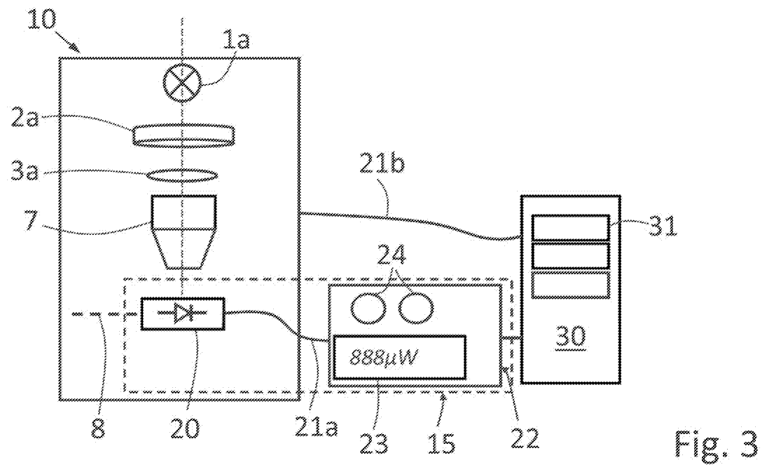

The reference signs specified for the prior art disclosed in FIGS. 1 and 2 also apply accordingly to the exemplary embodiment of the invention shown in FIG. 3.

The microscope 10 comprises a light source 1a, an attenuator 2a, a collimator lens 3a and an objective 7 along an indicated beam path. Further optical elements may be present. A measuring head 20 of a power meter 15 (surrounded by a broken solid line) is disposed in a sample plane 8. The measuring head 20 is used to capture a resultant power of radiation directed from the light source 1a into the sample plane 8. The measured values are transmitted via a line 21a to a display and operating unit 22 of the power meter 15. There, the measured value can be presented on a display 23. The power meter 15 can be operated by means of the operator control elements 24.

The measured values are transmitted further to a control unit 30. The latter is configured to capture a current configuration of optical elements in the beam path of the optical arrangement, to store the measured value in relation to the current configuration, to ascertain a relationship between the resultant power and an output power of the radiation on the basis of the stored measured values; and to generate control commands for setting an output power of the radiation on the basis of the stored measured values or on the basis of the relationship. For the purposes of storing the measured values in relation to the current configuration and for the purposes of storing the ascertained mathematical relationships, the control unit 30 has a memory unit 31 with a database.

The control commands can be transmitted via a further line 21b to the microscope 10 or to individual optical elements, more precisely to the drives or actuators thereof.

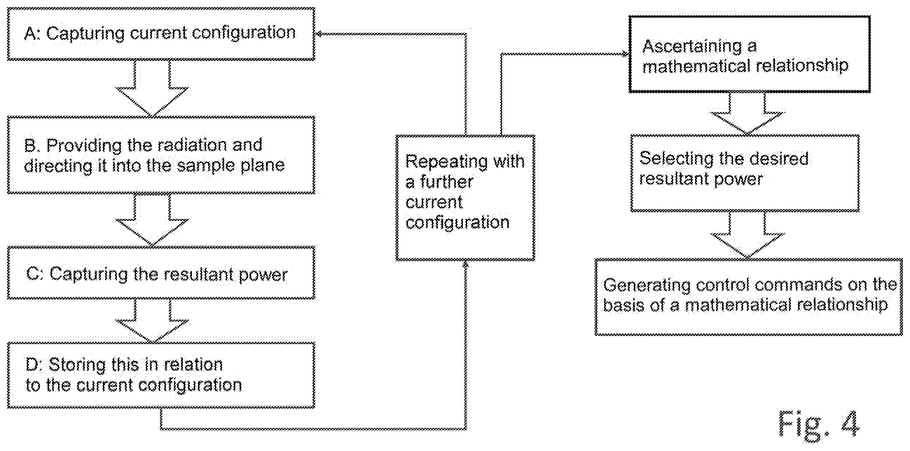

The flowchart of FIG. 4 presents an embodiment of the method according to the invention.

In a step A, a current configuration of optical elements in a beam path of the optical arrangement is captured. Provided radiation is directed along the beam path into the sample plane 8 (see FIGS. 1 and 3) (step B) and captured there as resultant power (measured value) (step C). The captured measured value is stored in relation to the current configuration of the optical arrangement (step D). Steps A to D are repeated for at least one further current configuration.

In a further embodiment of these fundamental steps for the invention, a mathematical relationship between the resultant power and an output power of the radiation and at least one configuration are ascertained on the basis of the measured values and said relationship is stored assigned to the relevant configuration. If the user desires a certain resultant power of a configuration of the sample plane, an output power of the radiation can be chosen and set accordingly on the basis of the mathematical relationship. Here, the desired resultant power need not correspond to the originally measured resultant power. The ascertained mathematical relationship allows the selection of a desired resultant power from a large value range. Corresponding control commands are generated and transmitted to the light source 1a, for example.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

### REFERENCE SIGNS

1a to 1d Light source/laser source
2a, 2b Attenuators
3a, 3b Collimator lenses
4 Main color splitter
5 Reflector turret
6 Output coupling means/secondary beam splitter
7 Objective
8 Sample/sample plane
10 Microscope
15 Power meter
20 Measuring head
21a Line
21b Further line
22 Display and operating unit
23 Display
24 Operator control element
25 Connector
30 Computer/control unit

What is claimed is:

1. Method for ascertaining a resultant power of radiation in a sample plane of an optical arrangement, comprising:
(A) capturing a current configuration of optical elements in a beam path of the optical arrangement;
(B) providing radiation and directing the radiation along the beam path into the sample plane;
(C) capturing at least one measured value of the power of the radiation in the sample plane as resultant power;
(D) storing the measured value in relation to the current configuration; and
(E) repeating steps A to D for at least one further current configuration.

2. Method according to claim 1, wherein a relationship between the resultant power and an output power of the radiation is ascertained on the basis of the stored measured values and said relationship is stored assigned to the at least one configuration.

3. Method according to claim 1, wherein a desired resultant power in the sample plane of a configuration to be used is selected and an output power of the radiation is set by means of appropriately generated control commands on the basis of the stored measured values or on the basis of the relationship, by virtue of a radiation source of the radiation and/or an attenuator disposed in the beam path being driven in such a way that the selected desired resultant power is brought about in the sample plane.

4. Method according to claim 1, wherein a selection of optical elements of a current configuration is made and steps A to D are carried out for the selected optical elements.

5. Optical arrangement for ascertaining a resultant power of radiation in a sample plane with a beam path along which radiation can be directed to a sample plane, comprising
at least one light source for providing the radiation;
optical elements for guiding and influencing the radiation in the beam path;
a measuring apparatus for capturing a resultant power of the radiation in a sample plane;
a control unit which is embodied to drive the at least one light source and/or at least one of the optical elements,
H wherein the measuring apparatus is connected to the control unit in a form suitable for the transmission of data; and
the control unit is configured
to capture a current configuration of optical elements in the beam path of the optical arrangement,
to store the measured value in relation to the current configuration,
to ascertain a relationship between the resultant power and an output power of the radiation on the basis of the stored measured values; and
to generate control commands for setting an output power of the radiation on the basis of the stored measured values or on the basis of the relationship.

6. Optical arrangement according to claim 5, wherein it is a constituent part of a scanning laser microscope.
